(19) United States
(12) Patent Application Publication
(10) Pub. No.: US 2025/0173202 A1
(43) Pub. Date: May 29, 2025

(54) SYSTEM AND METHOD FOR VISUALIZING ANOMALOUS DATA IN MESSAGE STREAMS

(71) Applicant: Aeronix, Inc., Melbourne, FL (US)

(72) Inventors: Levi Mutter, Melbourne, FL (US); Patrick Hagerty, Melbourne, FL (US); Ted Dubroff, Melbourne, FL (US)

(73) Assignee: Aeronix, Inc., Melbourne, FL (US)

(21) Appl. No.: 18/961,041

(22) Filed: Nov. 26, 2024

Related U.S. Application Data
(60) Provisional application No. 63/603,316, filed on Nov. 28, 2023.

(51) Int. Cl. G06F 9/54; G06F 11/07

(52) U.S. Cl. CPC G06F 9/546; G06F 11/0721; G06F 11/0769

(57) ABSTRACT

A method for analyzing digital data including the steps of: (1) receiving raw digital data; (2) encoding the raw digital data into event data stored in a standard file format; (3) utilizing a data communication interface standard to parse the event data into parsed event data stored in the standard file format; and (4) providing a visual representation of the parsed event data.

### RELATED APPLICATIONS

This application claims priority under 35 U.S.C. § 119 (e) of U.S. Provisional Patent Application Ser. No. 63/603,316 (Attorney Docket No. 1949.00021) filed on Nov. 28, 2023 and titled METHOD FOR VISUALIZING ANOMALOUS DATA IN UAI MESSAGE STREAMS. The content of this application is incorporated herein by reference.

### FIELD OF THE INVENTION

The present invention relates to systems and methods for analyzing data. More specifically, the invention is directed to a method of decoding digital data and converting it to a human readable format.

### BACKGROUND OF THE INVENTION

Universal Armament Interface (UAI) is a United States Department of Defense and North Atlantic Treaty Organization initiative to develop standardized functional interfaces in aircraft, weapons, and mission planning to support integration of future weapons independent of aircraft operational flight program cycles. Part of the UAI focuses on the electrical bus and signals passed between the aircraft and the weapon in accordance with MIL-STD-1760 and AS-5725.

UAI is based on MIL-STD-1760 from an architectural and electrical point of view, but the messages and rule sets have been expanded to handle a wide range of munitions for the modern platform. UAI provides a host of complementary details and requirements on how messages should be filled out and when they should be sent. UAI also specifies the EBR-1553 data bus standard, operating at 10 megabits, an order of magnitude faster than the original 1553 bus.

A common use case of these standards in weapons systems involves the aircraft or platform communicating with a carriage store through the aircraft's Aircraft Store Interface (ASI) to the carriage store's Carriage Store Interface (CSI). Many platforms in use today have a standard MIL-STD-1553 interface between the ASI and CSI. A modern carriage store may accept MIL-STD-1760 in the CSI but communicate with UAI and EBR-1553 to the mission stores through the Carriage Station Store Interface (CSSI) to the munition's Mission Store Interface (MSI).

MIL-STD-1760, released at revision B in 1992, was developed to standardize this interface between the pylon and the store of the aircraft and to minimize the proliferation of electrical and optical interface variations that grew out of unique implementations on each platform. As a part of this standard, a communication protocol was established to communicate over a MIL-STD-1553 bus between the aircraft platform and connected stores. MIL-STD-1760 describes the pertinent vocabulary, the electrical bus, and the message set for communicating between the platform weapons controller and the connected stores.

During the development and integration of new stores into UAI systems, visibility into the data on the physical bus is critical in determining the source of errors during the sequences described above. As the development of the platform to munition interface matures, a single tool to understand exactly what happened on the UAI interface in an easy-to-read format would significantly reduce debugging time by removing the steps required to translate raw bus captures and discrete signal state changes into meaningful insights. Depending on what stage of the design and integration process the munition, carriage, or platform is in, the need for visibility into the physical bus may need to be a live state through monitoring hardware, or by analyzing raw data capture logs after an event in question.

There exists a need for a device that can read, parse and display messages using the MIL-STD-1553 interface, MIL-STD-1760 interface, and UAI and can also test other UAI rules and requirements including message contents, timing, and sequencing.

A need also exists for a UAI decoder that analyzes UAI signals, provides a graphical user interface allowing for in-depth analysis of messages sent on the UAI, and provides analysis information in a human-readable format.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to a method for analyzing digital data including the steps of: (1) receiving raw digital data; (2) encoding the raw digital data into event data stored in a standard file format; (3) utilizing a data communication interface standard to parse the event data into parsed event data stored in the standard file format; and (4) providing a visual representation of the parsed event data.

The standard file format may be XML.

The visual representation may include a time stamp associated with the parsed event data.

The parsed event data may include a plurality of messages.

Each of the plurality of messages may be displayed in the visual representation.

Each of the plurality of messages may have a message type and the visual representation may be filtered by the message type.

Each of the plurality of messages may include a field with a value and the visual representation may be filtered by the value.

The method may further include the steps of: (1) identifying an error in the plurality of messages; and (2) providing a visual indication of the error.

The method may still further include the steps of: (1) selecting an event in the visual representation; (2) displaying a portion of raw digital data associated with the event; (3) displaying a portion of event data associated with the event; and (4) displaying a portion of parsed event data associated with the event.

The method yet further may include the steps of: (1) selecting an event in the visual representation; and (2) displaying a binary view of the raw digital data associated with the event.

The method may further include the step of displaying ASCII text of the raw digital data associated with the event.

Another embodiment of the method for analyzing digital data may include the steps of: (1) receiving a first channel of raw digital data; (2) encoding the first channel of raw digital data into first event data stored in a first standard file format; (3) utilizing a first data communication interface standard to parse the first event data into first parsed event data stored in the first standard file format; (4) receiving a second channel of raw digital data; (5) encoding the second channel of raw digital data into second event data stored in a second standard file format; (6) utilizing a second data communication interface standard to parse the second event data into parsed second event data stored in the second standard file format; and (7) providing a visual representation of the first parsed event data and the second parsed event data.

The first standard file format may be the same as the second standard file format.

The visual representation of the first parsed event data may be synchronized to the second parsed event data.

The parsed first event data may include a first plurality of messages and the parsed second event data may include a second plurality of messages. Each of the first plurality of messages and second plurality of messages may be displayed in the visual representation.

Each of the first plurality of messages and second plurality of messages may have a message type and the visual representation may be filtered by the message type.

Each of the first plurality of messages and second plurality of message may include a field with a value and the visual representation may be filtered by the value.

The method may further include the steps of: (1) selecting an event in the visual representation; (2) displaying a portion of raw digital data associated with the event; (3) displaying a portion of event data associated with the event; and (4) displaying a portion of parsed event data associated with the event.

One embodiment of the method for analyzing digital data may include the steps of: (1) receiving a first channel of raw digital data; (2) encoding the first channel of raw digital data into first event data stored in a standard file format; (3) utilizing a data communication interface standard to parse the first event data into first parsed event data stored in the standard file format, wherein the first parsed event data includes a first plurality of messages; (4) receiving a second channel of raw digital data; (5) encoding the second channel of raw digital data into second event data stored in the standard file format; (6) utilizing the data communication interface standard to parse the second event data into parsed second event data stored in the standard file format, wherein the parsed second event data includes a second plurality of messages; and (7) providing a synchronized visual representation of each of the first plurality of messages and the second plurality of messages.

Each of the first plurality of messages and second plurality of messages may have a message type and the visual representation may be filtered by the message type.

Each of the first plurality of messages and second plurality of message may include a field with a value and the visual representation may be filtered by the value.

### BRIEF DESCRIPTION OF THE DRAWINGS

Some embodiments of the present invention are illustrated as an example and are not limited by the figures of the accompanying drawings, in which like references may indicate similar elements.

FIG. 1 is a block diagram of the system for analyzing and displaying UAI message information according to an embodiment of the invention.

FIG. 2 is the message table view of the system according to an embodiment of the invention.

FIG. 3 is the message table view of the system according to another embodiment of the invention.

FIG. 4 is the message table view of the system according to another embodiment of the invention.

FIG. 5 is the message table view of the system with quick filter choice display according to an embodiment of the present invention.

FIG. 6 is the message table view of the system with quick filter choice display according to another embodiment of the present invention.

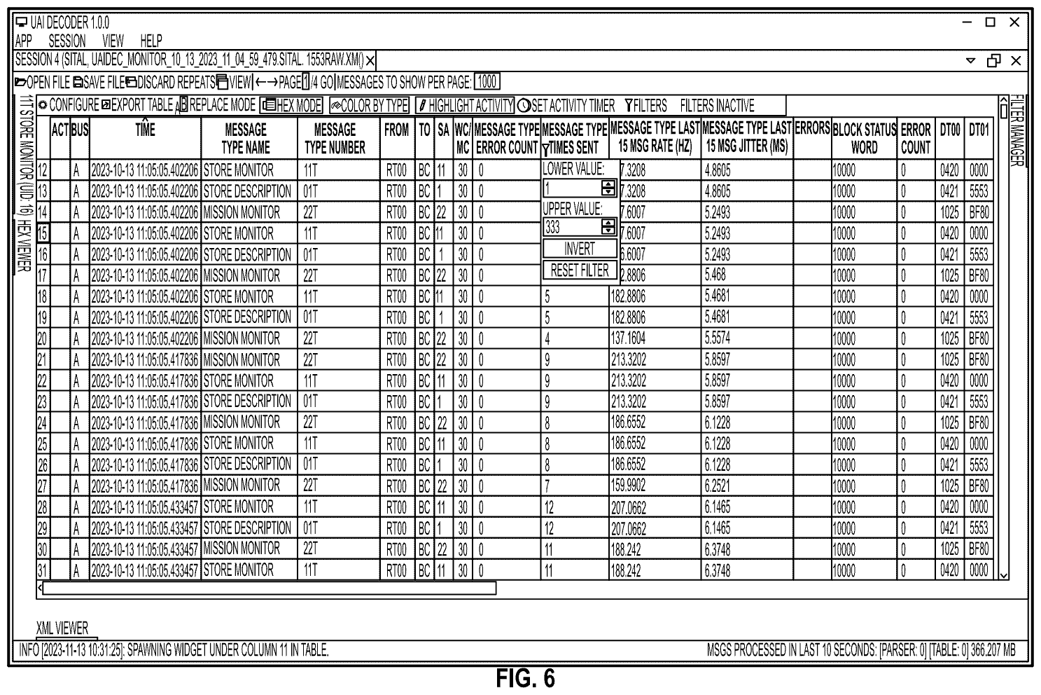

FIG. 7 is the message table view of the system with filtering according to an embodiment of the present invention.

FIG. 8 is the message table view of the system with a filter according to an embodiment of the present invention.

FIG. 9 is the message table view of the system displaying a plurality of errors according to an embodiment of the present invention.

FIG. 10 is the message tree view of the system according to an embodiment of the present invention.

FIG. 11 is the message binary view of the system according to an embodiment of the present invention.

FIG. 12 is the message binary view of the system according to an embodiment of the present invention.

FIG. 13 is the GUI view “X” of the system according to an embodiment of the present invention.

FIG. 14 is a method for analyzing digital data according to an embodiment of the present invention.

FIG. 15 is a method for analyzing digital data according to an embodiment of the present invention.

FIG. 16 is a method for analyzing digital data according to an embodiment of the present invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

An embodiment of the invention, as shown and described by the various figures and accompanying text, provides a system for analyzing and displaying Universal Armament Interface (UAI) message information 100. The system 100 may include a decoder engine 110 and a graphical user interface engine 120.

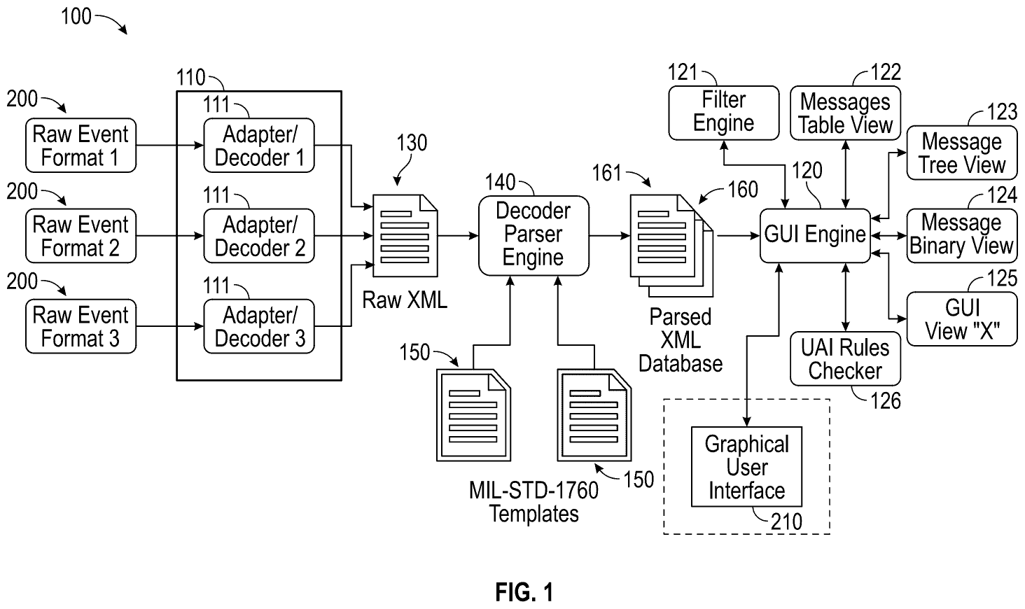

FIG. 1 depicts the system 100 according to an embodiment of the present invention. The decoder engine 110 may receive raw message data 200, which may be binary or ASCII and may be provided in multiple formats. By way of example, and not as a limitation, the raw message data 200 may be UAI message information. The raw message data 200 may include event data, including, but not limited to, raw message data, signal states, and other metadata around the event. The decoder engine 110 may decode the raw message data 200, and provide human-readable, unparsed XML format data 130 to a decoder parser engine 140. The decoder parser engine 140 may receive the unparsed XML format data 130 and utilize data templates 150, which may include, but are not limited to MIL-STD-1760 templates, to output a parsed XML database 160. This parsed XML database 160 is provided to the graphical user interface engine 120. The system 100 may provide the parsed XML database 160 regardless of the hardware used within the system being analyzed.

After raw message data 200 has been input to the decoder engine 110 and the unparsed XML format data 130 is created, the decoder parser engine 140 may be driven by a plurality of data templates 150, including, but not limited to XML templates of every type of UAI/MIL-STD-1760 message. The output of the decoder parser engine 140 is a second XML document that contains human-readable information, which is referred to as the parsed XML format data 161. A parsed XML format data file 161 contains the decoded value of every word and field of the unparsed XML format data 130 on a per message basis as described by the data template 150 utilized by the decoder parser engine 140. Multiple of these parsed XML format data files 161 may be bundled into a parsed XML database 160 that can be accessed by the graphical user interface engine 120.

The GUI engine 120 may interface with a filter engine 121, multiple views 122, 123, 124, 125, and a UAI rules checker module 126 to provide data that is displayed on a graphical user interface 210. The views may include, but are not limited to, a messages table view 122, message tree view 123, message binary view 124, and GUI view “X” 125.

The graphical user interface engine 120 may propagate the parsed XML format data 161 to the various graphical user interface views 122, 123, 124, 125 that are registered with the graphical user interface engine 120. Each view 122, 123, 124, 125 may depend on the well-known XML format and use powerful XML processing tools to create custom visuals within the overall system 100. The parsed XML database 160 may also be provided to 3rd party tools external to the system 100 to allow for custom integrations with the system 100. In one embodiment, external views may be added as plugins to the system 100, providing a seamless integration.

The views 122, 123, 124, 125 may hook into the graphical user interface engine 120 to do several things. Each view 122, 123, 124, 125 may ask the graphical user interface engine 120 to provide it with all new messages or just with specific messages, which may be identified by UID. Each view 122, 123, 124, 125 may ask the graphical user interface engine 120 to resend all previous data.

Selections of which data the graphical user interface engine 120 is to send may be synchronized across all views 122, 123, 124, 125. Each view may hook into this selection signal system to send and receive selections themselves. For example, if a data word is selected in the Messages Table View 122, the Message Tree View 123, which displays the data word's decoded values, may select the relevant item within the tree, and vice versa. This graphical user interface engine 120 may handle both file parsing and live hardware snooping. Both are handled in such a way that a stable view of the input is exposed to the remainder of the views.

The system for analyzing and displaying UAI message information 100 includes a decoder engine 110 with a plurality of adapter/decoders 111. Each of the adapters/decoders 111 may work directly with hardware snoopers, or from files created by hardware snoopers. One of the adapters/decoders 111, by way of example and not as a limitation, may be designed for a Sital MultiComBox EBR-1553 USB device. This USB device may be used to directly connect to UAI compliant hardware and display decoded data in real-time. The decoder engine 110 of the system 110 is designed to keep up with the UAI data rate on the bus of the USB device and remain responsive while loading data. Adapters/decoders 111 may additionally include support for a Ballard EBR-1553 USB.

The system 100 may save unparsed XML format data 130 to a compressed. zip file, which can then be loaded at any time into the decoder parser engine 140. The compressed.zip file may be loaded while the system is decoding data from hardware in another session. The system 100 may allow any number of sessions to be opened at once. Such a configuration allows for processing saved.zip files and data received from live hardware in parallel. Each session of the system may appear as a tab that the user can rearrange using the docking system of the graphical user interface 210.

The decoder engine 110 may support having multiple open sessions, each of the sessions may be either connections to bus monitors or opened files. An opened file session may be a previously recorded unparsed XML format data 130 files or a .txt file recorded from a hardware snooper.

A plurality of sessions may be cross correlated by timestamp. This means that a user can select an event of interest in one session, and visually see what was happening at that time in all other sessions. This allows for powerful, at-a-glance debug capability to understand how the carriage store system may be working.

The system 100 provides a docking graphical user interface 210 to users.

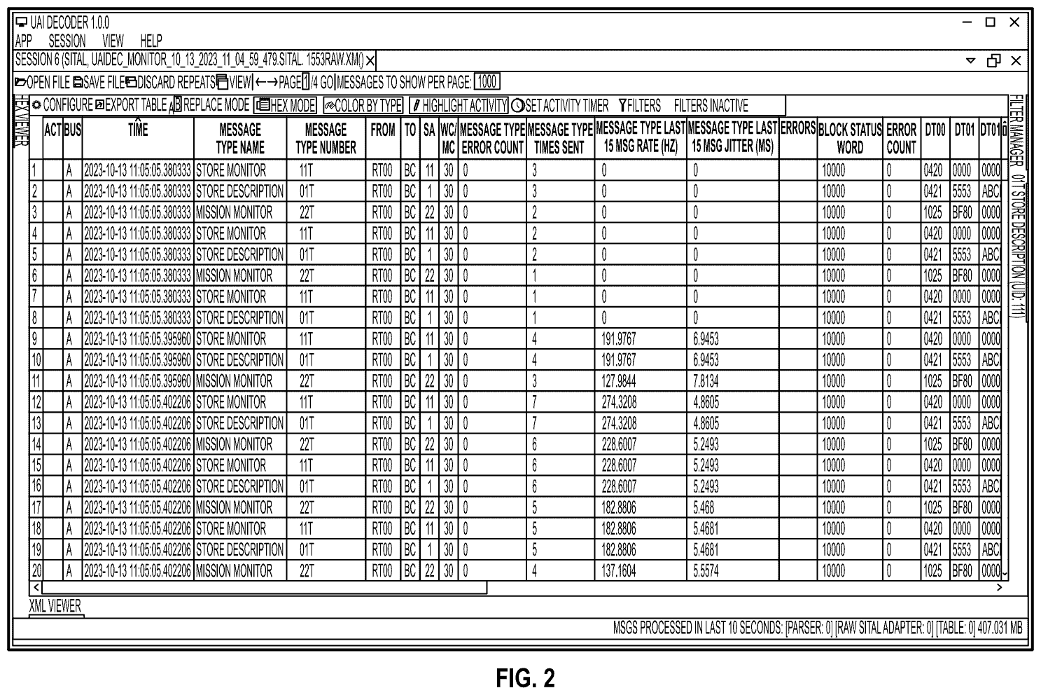

The message table view 122 may show all the events that have either been read from a hardware bus snooper or from the unparsed XML format data 130 file. An event may be either a message or a change in a discrete signal. The message table view 122 may have several columns that break the event into different sections of data, as depicted in FIG. 2.

The data shown in the table of the message table view 122, and its format, are completely user-customizable using an XML configuration file utilizing XPath queries. Multiple configuration files are supported by the system to allow users to select the desired view of the data. Additionally, rich text is supported within the table cells, meaning HTML can be used to specify the cell's formatting with any number of queries.

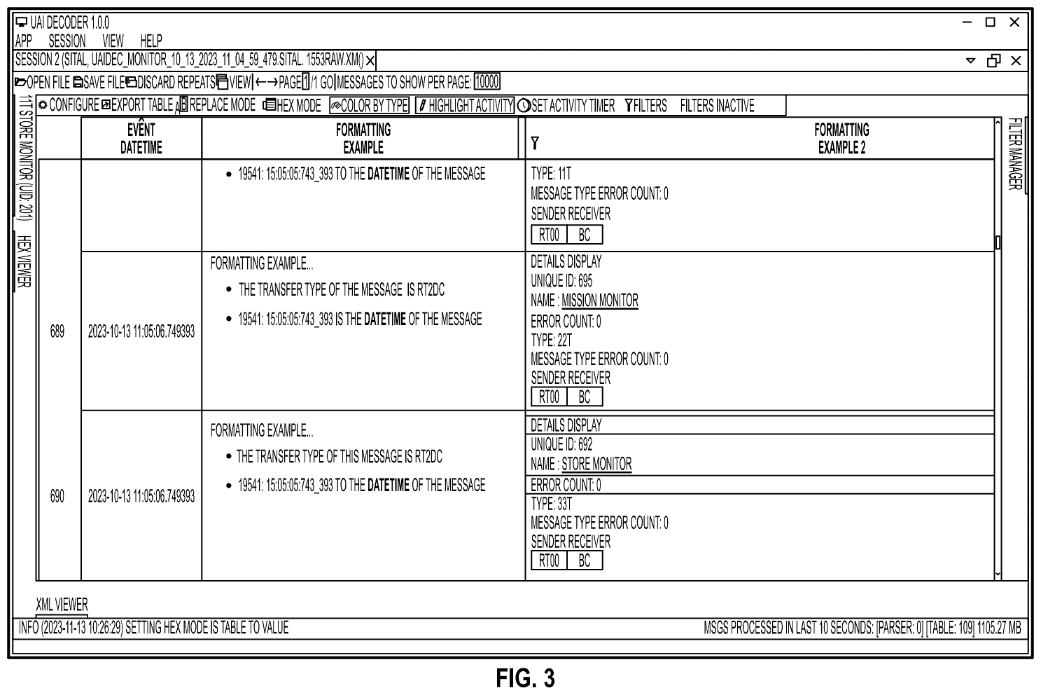

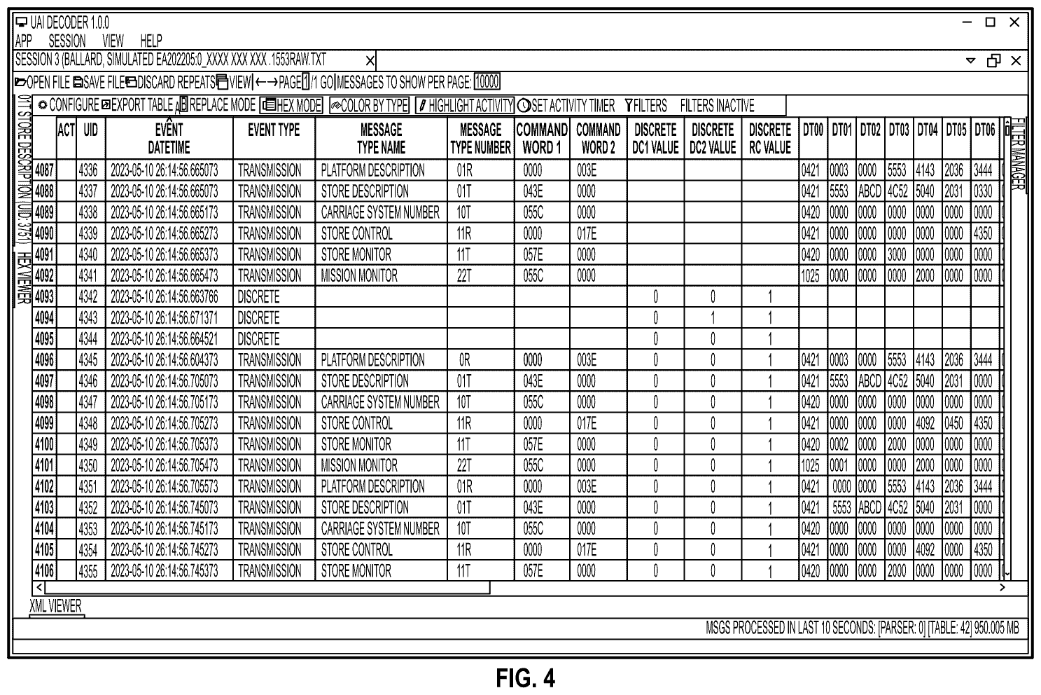

FIG. 3 depicts the display of discrete changes tracked as events by the decoder parser engine 140. The state of discrete events may be interpreted and tracked based on previous discrete events, as depicted in FIG. 4. Events that follow a discrete change are displayed with the discrete state at the time of the event as metadata in XML.

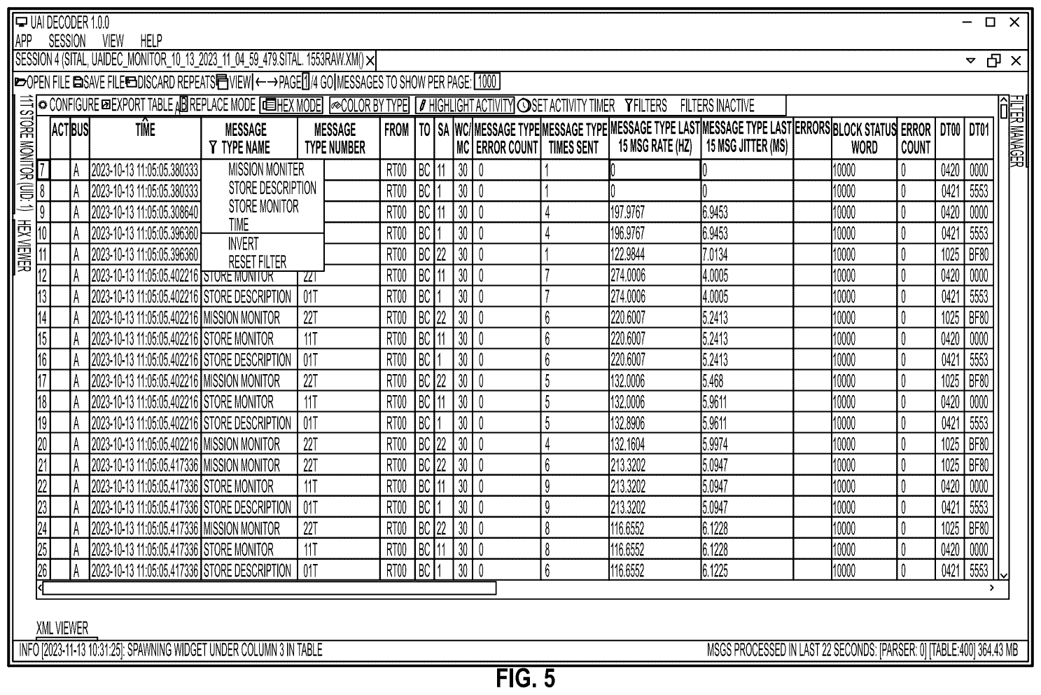

The system 100 may have a comprehensive filtering protocol. At least two kinds of data may be filtered: column values and field values. Column values are defined as the text as it is displayed in the cell, which can be either text or numbers. The underlying type is specified in the table configuration, which the filter system will behave appropriate to. As depicted in FIGS. 5 & 6, selecting a column type results in the graphical user interface 210 displaying quick filter choices based on the data presented in the column. As shown in FIGS. 5 & 6, the data types of selected columns are different. Therefore, the quick filter choices displayed by the graphical user interface 210 are different.

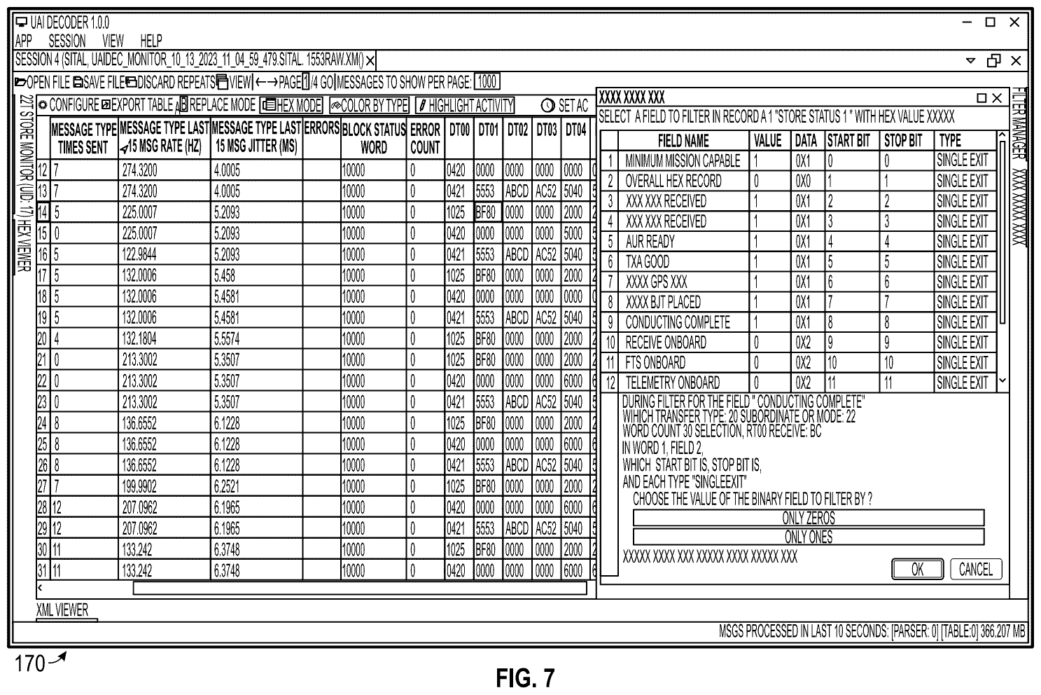

As shown in FIG. 7, for embodiments in which the cell contains 1553 data word field values, different view interfaces may be used depending on the field's underlying data type found in the UAI specification. By way of example, and not as a limitation, to filter for instances where the binary field “Conditioning Complete” is set to 1 in this data, a user may right-click on a data word field. This may bring up the side panel widget 170 that displays all fields found in that data word. When one of these words is clicked, a data type-appropriate widget may be added to the bottom of the side panel widget 170, allowing for user input. As depicted in FIG. 7, because “Conditioning Complete” is a binary value, the user may select to either query for ones or zeros in the filter.

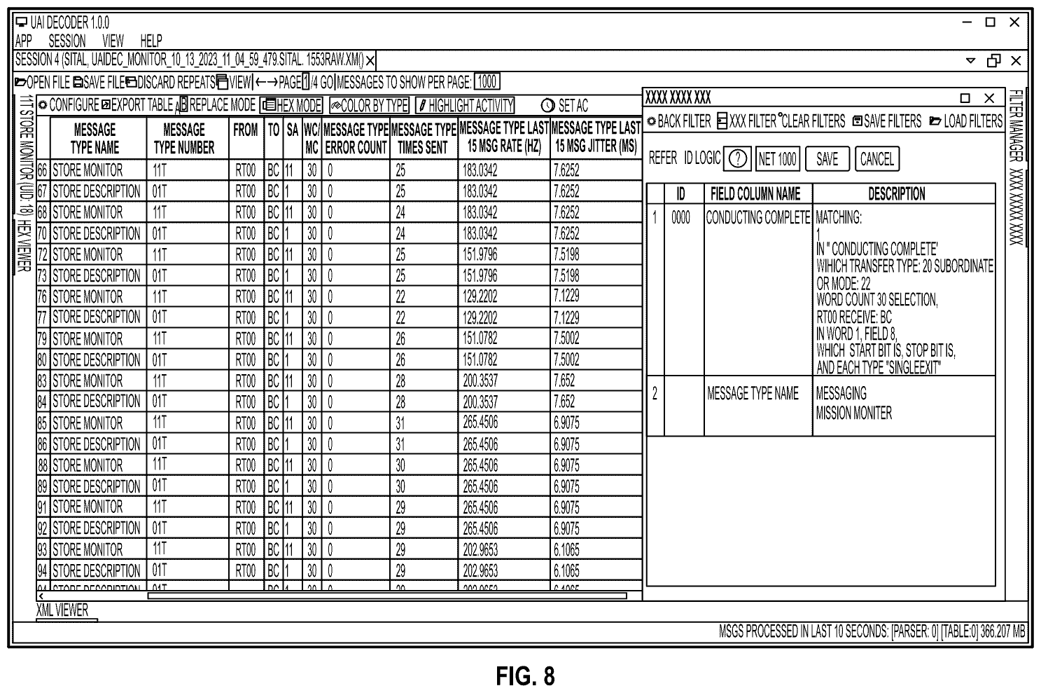

As shown in FIG. 8, when filters are created, each filter may be given a unique ID that can be used to create more complex queries. The default logic used when adding filters may be to AND every filter, intersecting them and showing all results that match the filter in the table. However, the keywords AND, OR, and NOT may be used to create more complex queries. This may allow users to create detailed filters for the data they want to see.

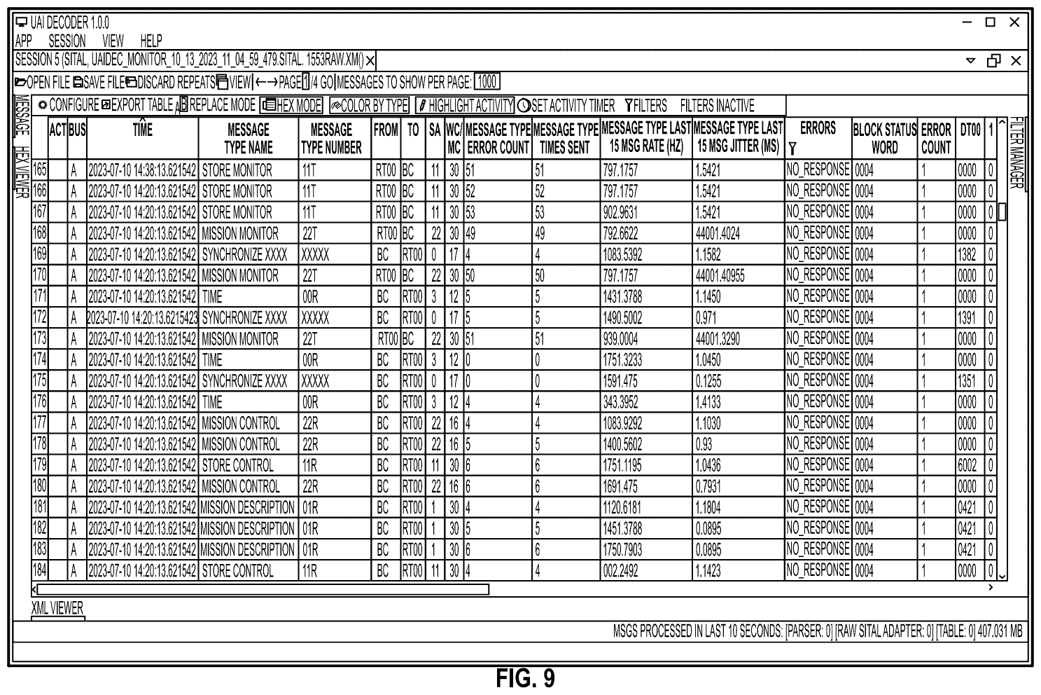

As shown in FIG. 9, any errors, including, but not limited to, those on the hardware level, may be stored in the metadata of the parsed XML format data 161. The table may be configured to show errors and error counts with a shaded or different colored background for visibility. An activity column type may be provided. The activity column may fade at a user-definable rate when viewing live snooped data and may be permanent when viewing unparsed XML format data files 130. The shaded or different colored background for text cells may also be configured to fade over time.

The message table view 122 may be exported to an HTML file for use outside of the system 100. The export may preserve color and formatting of the message table view 122.

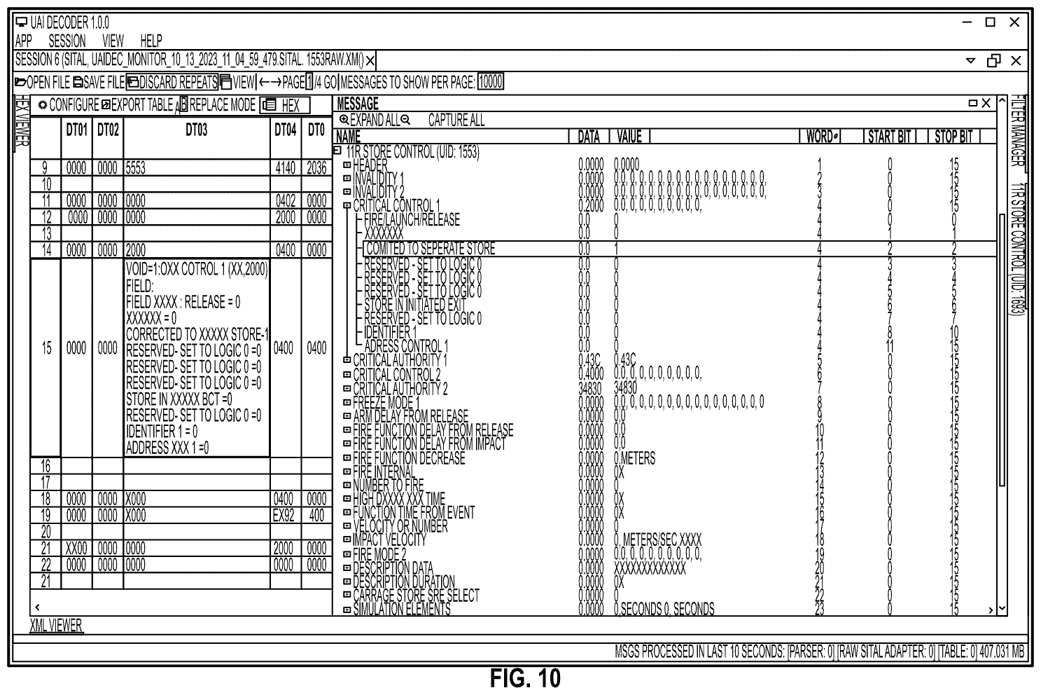

Clicking on a message in the message table view 122 may load that same message in a message tree view 123, which is depicted in FIG. 10. The message tree view 122 may show the selected message correlating directly with the standard. The raw message data 200 may be shown as well as unparsed XML format data 130 or parsed XML format data 161. A description may be provided for each word, as well as for each field inside a word. Users can visually determine if a field is composed correctly. If not, users may visually determine that a specific field, at specific bit locations, in a specific word location is in error.

The message tree view 123 may decode the specified field values according to the UAI specification, accounting for the specification's unique data types and number representations. The message tree view 123 may also includes the unit type that the field specifies, as shown in FIG. 10, including, but not limited to, meters, us, seconds, and the like.

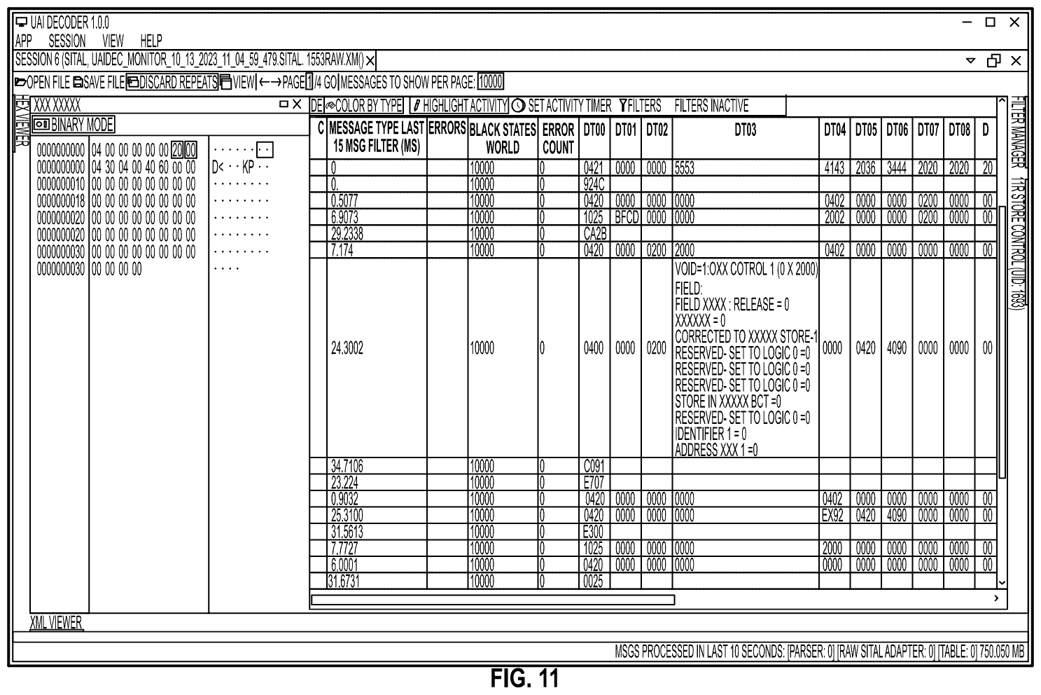

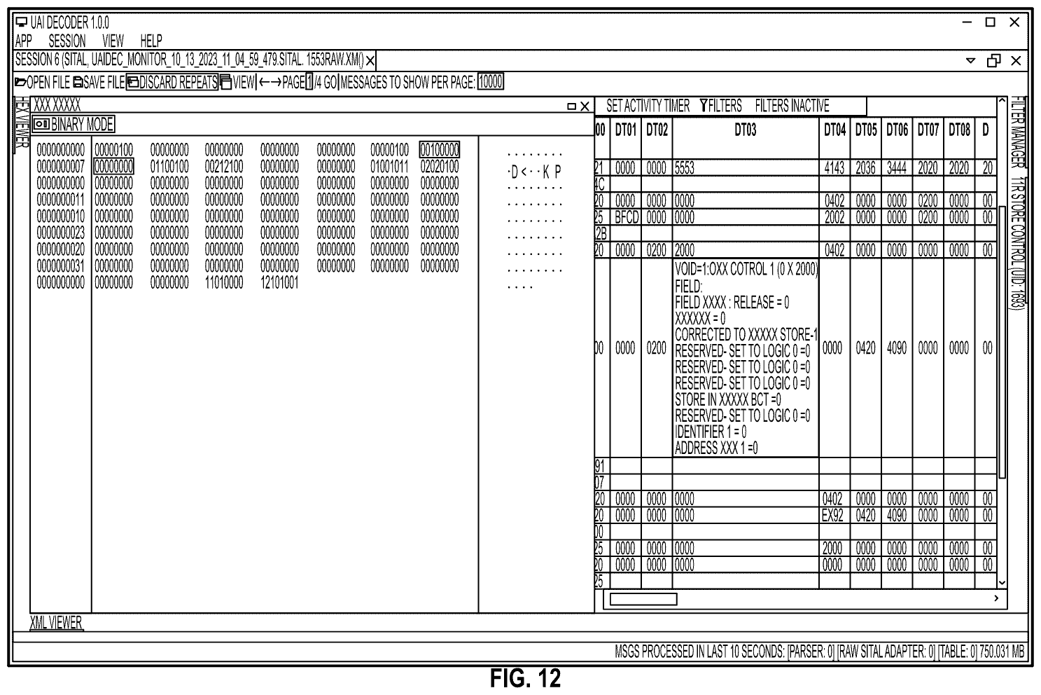

Selecting a message in the message table view 122 may load the selected message in a message binary view 124, which is depicted in FIGS. 11 & 12. The message binary view 124 may allow a user to easily see the 1's and 0's, as shown in FIG. 12, or hex representation, as shown in FIG. 11, of every data word. The message binary view 124 may also show any data that can be displayed as ASCII text. Presenting the data in this way may be helpful to see how the ASCII text is displayed in relation to the binary message. The user may easily toggle between viewing data as binary and viewing data as hex, with the selected word remaining selected in both modes. Selecting words in the message binary view may select the words in other views and vice versa.

Users may no longer have to refer to the specification to see what each field is, how it should be decoded, and what it means. The system 100 provides all this information at a glance.

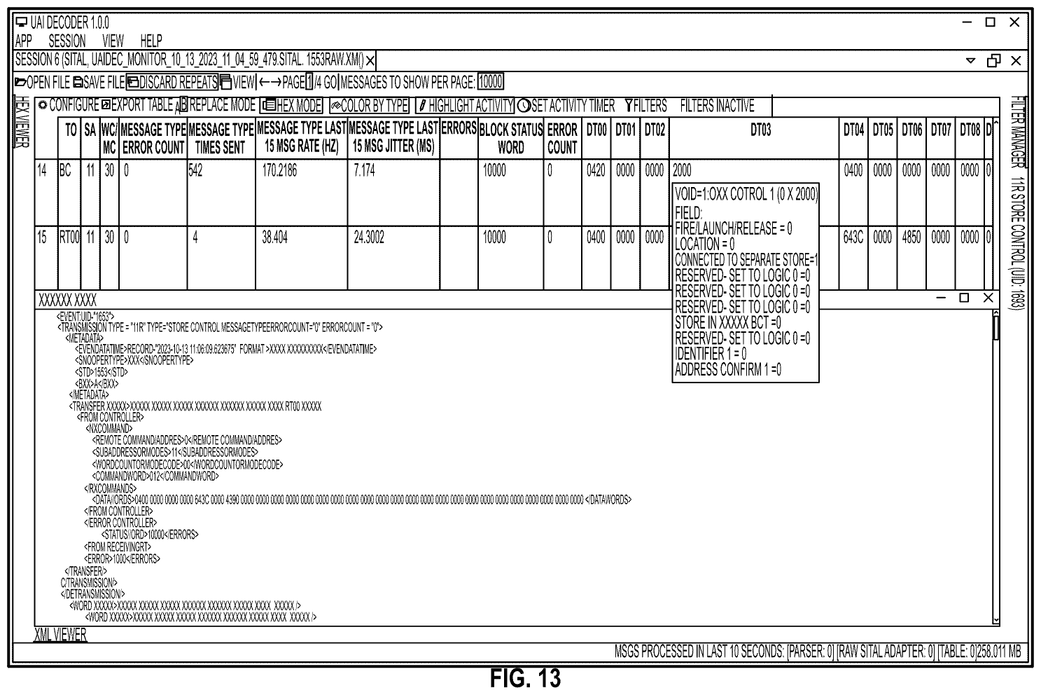

Selecting a message in the message table view 122 may loads that same message in a GUI view “X” 125. This view 125 may allows the user to see the underlying parsed XML format data 161 that represents the decoded message event, as shown in FIG. 13. Because all data is saved in XML, this display may provide powerful decoding and collaboration tools.

The inventive system 100 may allow a user to provide threshold parameters that are utilized to provide visual indications to the user. In one embodiment, by way of example, and not as a limitation, the threshold parameter may be a specific value, a range, a high limit, a low limit, or the like. Each threshold parameter may be associated with one or more values of the threshold parameter. The system may provide a visual indication to the user when one or more fields in a message contain information matching or falling within the range of the value of the threshold parameter.

By way of example, and not as a limitation, in embodiments in which a threshold value of a specific value is utilized, the system 100 may highlight all information associated with a message in which the value of one or more fields of the message is not equal to the specified value. One having skill in the art will appreciate that the system may similarly highlight all information associated with a message in which the value of one or more fields of the message is equal to the specified value. In embodiments in which the threshold value is a high limit of one or more fields, the system may highlight one or more fields of a message that has a value exceeding the threshold value of the field. In embodiments in which the threshold value is a low limit of one or more fields, the system may highlight one or more fields of a message that has a value less than the threshold value of the field.

In embodiments in which the threshold value is a range of one or more fields, the user may provide both a high limit and a low limit value and the system may highlight one or more fields of a message that has a value either exceeding the high limit or below the low limit value of the field. Those with skill in the art will appreciate that in embodiments in which the threshold value is a range, the system may similarly highlight one or more fields of a message that has a value both below the high limit and above the low limit value of the field.

One or more message fields may be highlighted, by way of example, and not as a limitation, by changing the background color, font color, font size, font type, or font style of the field.

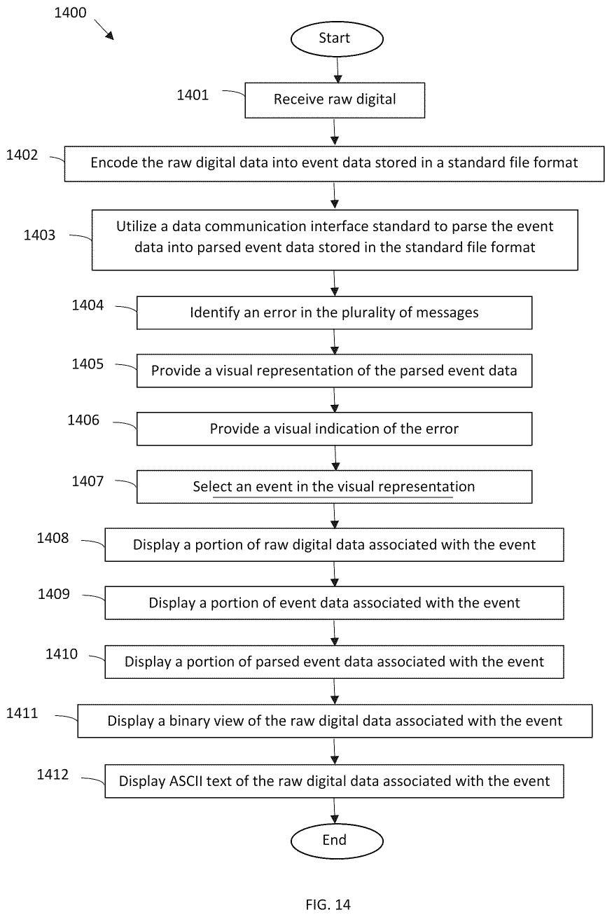

Turning to FIG. 14, a method for analyzing digital data 1400 is depicted. In the embodiment, the method may include the steps of receiving raw data 1401, encoding the raw digital data into event data stored in a standard file format 1402, utilizing a data communication interface standard to parse the event data into parsed event data stored in the standard file format 1403, identifying an error in the plurality of messages 1404, providing a visual representation of the parsed event data 1405, providing a visual indication of the error 1406, selecting an event in the visual representation 1407, displaying a portion of raw digital data associated with the event 1408, displaying a portion of event data associated with the event 1409, displaying a portion of parsed event data associated with the event 1410, displaying a binary view of the raw digital data associated with the event 1411, and displaying ASCII text of the raw digital data associated with the event.

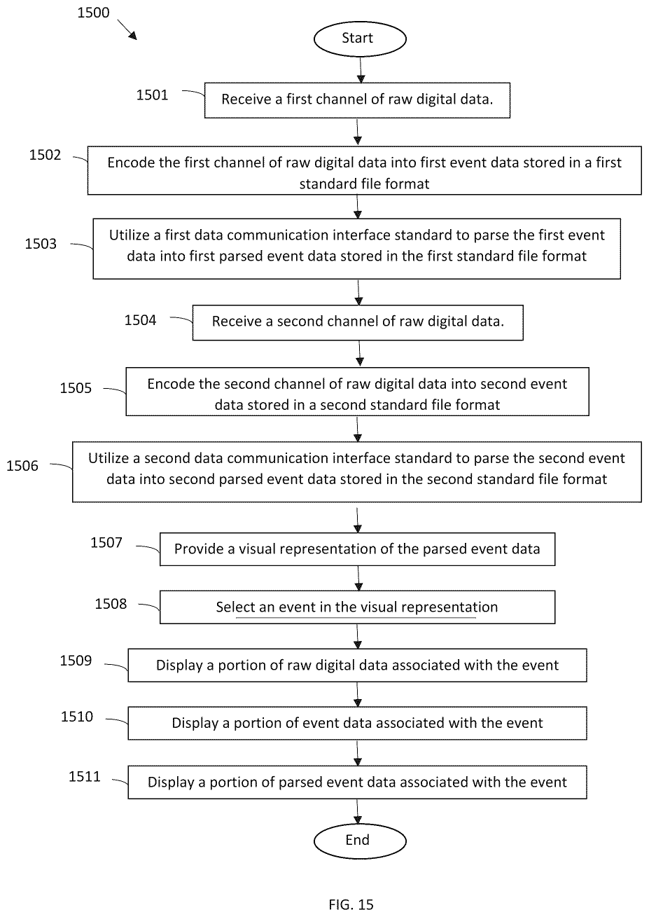

Turning to FIG. 15, another embodiment of a method for analyzing digital data 1500 is depicted. In this embodiment, a first channel of raw digital data may be received 1501. The first channel of raw digital data may be encoded into a first event data stored in a first standard file format 1502. A first data communication interface standard may be utilized to parse the first event data into first parsed event data, which may be stored in the first standard file format 1503. A second channel of raw digital data may be received 1504. The second channel of raw digital data may be encoded into second event data, which may be stored in a second standard file format 1505. A second data communication interface standard may be utilized to parse the second event data into second parsed event data, which may be stored in the second standard file format 1506. A visual representation of the parsed event data may be provided 1507. An event may be selected in the visual representation 1508. A portion of raw digital data associated with the event may be displayed 1509. A portion of event data associated with the event may be displayed 1510. A portion of parsed event data associated with the event may be displayed 1511.

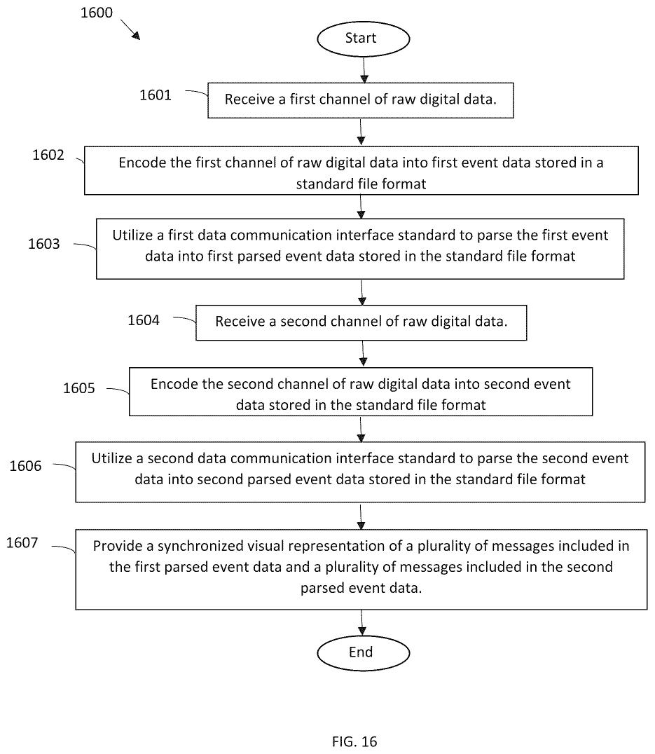

FIG. 16 depicts another embodiment of a method for analyzing digital data 1600. This embodiment may include the steps of receiving a first channel of raw digital data 1601, encoding the first channel of raw digital data into first event data stored in a standard file format 1602, utilizing a data communication interface standard to parse the first event data into first parsed event data stored in the standard file format 1603, receiving a second channel of raw digital data 1604, encoding the second channel of raw digital data into second event data stored in the standard file format 1605, utilizing the data communication interface standard to parse the second event data into second parsed event data stored in the standard file format 1606, and providing a synchronized visual representation of a plurality of messages included in the first parsed event data and a plurality of messages included in the second parsed event data 1607.

Any combination of the parameters described above are also available.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus the scope of the invention should be determined by the appended claims and their legal equivalents, and not by the examples given.

What is claimed is:

1. A method for analyzing digital data comprising the steps of:
receiving raw digital data;
encoding the raw digital data into event data stored in a standard file format;
utilizing a data communication interface standard to parse the event data into parsed event data stored in the standard file format; and
providing a visual representation of the parsed event data.

2. The method of claim 1 wherein the standard file format is XML.

3. The method of claim 1 wherein the visual representation includes a time stamp associated with the parsed event data.

4. The method of claim 1 wherein the parsed event data includes a plurality of messages.

5. The method of claim 4 wherein each of the plurality of messages is displayed in the visual representation.

6. The method of claim 4 wherein each of the plurality of messages has a message type and the visual representation may be filtered by the message type.

7. The method of claim 4 wherein each of the plurality of messages includes a field with a value and the visual representation may be filtered by the value.

8. The method of claim 4 further comprising the steps of:
identifying an error in the plurality of messages; and
providing a visual indication of the error.

9. The method of claim 1 further comprising the steps of:
selecting an event in the visual representation;
displaying a portion of raw digital data associated with the event;
displaying a portion of event data associated with the event; and
displaying a portion of parsed event data associated with the event.

10. The method of claim 1 further comprising the steps of:
selecting an event in the visual representation; and
displaying a binary view of the raw digital data associated with the event.

11. The method of claim 10 further comprising the step of:
displaying ASCII text of the raw digital data associated with the event.

12. A method for analyzing digital data comprising the steps of:
receiving a first channel of raw digital data;
encoding the first channel of raw digital data into first event data stored in a first standard file format;
utilizing a first data communication interface standard to parse the first event data into first parsed event data stored in the first standard file format;
receiving a second channel of raw digital data;
encoding the second channel of raw digital data into second event data stored in a second standard file format;
utilizing a second data communication interface standard to parse the second event data into parsed second event data stored in the second standard file format; and
providing a visual representation of the first parsed event data and the second parsed event data.

13. The method of claim 12 wherein the first standard file format is the same as the second standard file format.

14. The method of claim 12 wherein the visual representation of the first parsed event data is synchronized to the second parsed event data.

15. The method of claim 12 wherein the parsed first event data includes a first plurality of messages and the parsed second event data includes a second plurality of messages.

16. The method of claim 15 wherein each of the first plurality of messages and second plurality of messages are displayed in the visual representation.

17. The method of claim 15 wherein each of the first plurality of messages and second plurality of messages has a message type and the visual representation may be filtered by the message type.

18. The method of claim 15 wherein each of the first plurality of messages and second plurality of message includes a field with a value and the visual representation may be filtered by the value.

19. The method of claim 12 further comprising the steps of:
selecting an event in the visual representation;
displaying a portion of raw digital data associated with the event;
displaying a portion of event data associated with the event; and
displaying a portion of parsed event data associated with the event.

20. A method for analyzing digital data comprising the steps of:
receiving a first channel of raw digital data;
encoding the first channel of raw digital data into first event data stored in a standard file format;
utilizing a data communication interface standard to parse the first event data into first parsed event data stored in the standard file format, wherein the first parsed event data includes a first plurality of messages;
receiving a second channel of raw digital data;
encoding the second channel of raw digital data into second event data stored in the standard file format;
utilizing the data communication interface standard to parse the second event data into parsed second event data stored in the standard file format, wherein the parsed second event data includes a second plurality of messages; and
providing a synchronized visual representation of each of the first plurality of messages and the second plurality of messages;
wherein each of the first plurality of messages and second plurality of messages has a message type and the visual representation may be filtered by the message type; and
wherein each of the first plurality of messages and second plurality of message includes a field with a value and the visual representation may be filtered by the value.
